(19) United States
(12) Patent Application Publication
(10) Pub. No.: US 2024/0427839 A1
(43) Pub. Date: Dec. 26, 2024

(54) Methods And Apparatus For Matrix Processing In A Neural Network Processing System

(71) Applicant: Expedera, Inc., Palo Alto, CA (US)

(72) Inventors: Sharad Vasantrao Chole, San Jose, CA (US); Shang-Tse Chuang, Los Altos, CA (US); Siyad Chih-Hua Ma, Palo Alto, CA (US)

(21) Appl. No.: 18/212,648

(22) Filed: Jun. 21, 2023

(51) Int. Cl. G06F 17/16; G06N 3/063

(52) U.S. Cl. CPC G06F 17/16; G06N 3/063

(57) ABSTRACT

Artificial intelligence is an increasingly important sector of the computer industry. However, artificial intelligence is extremely computationally intensive field such that it can be expensive, time consuming, and energy consuming. Fortunately, many of the calculations required for artificial intelligence can be performed in parallel such that specialized processors can great increase computational performance. Specifically, artificial intelligence generally requires large numbers of matrix operations to implement neural networks such that specialized matrix processor circuits can improve performance. Thus, this document discloses apparatus and methods for efficiently processing matrix operations.

### TECHNICAL FIELD

The present invention relates to the field of digital processing circuits. In particular, but not by way of limitation, the present invention discloses digital circuit designs and methods for performing matrix mathematical operations.

### BACKGROUND

Computer system designers are always attempting to design more powerful computer systems. Powerful computer systems allow for extremely complex computational models such as weather prediction, protein-folding, celestial mechanics, quantum mechanics, artificial intelligence, and complex three-dimensional video renderings to be performed faster and with greater precision. Furthermore, the computational models being simulated can be made ever more detailed thus rendering more accurate results.

To design more powerful computer systems, many different techniques may be employed. One of the simplest techniques is to increase the clock speed at which computer systems operate although it is becoming much more difficult to increase the clock speed due to the physics of current transistor materials. Processing wider data structures can also increase computer performance, but this only helps for certain types of computational tasks that can take advantage of wider data structures. Two popular techniques for improving processing speeds are parallel processing such as implementing multiple computational cores within a computer processor and combining thousands of different computer systems on a computer network to cooperate on a single computational problem.

One of the computer science fields most in need of more powerful processors is the field of Artificial Intelligence (AI). Artificial Intelligence is increasingly being used for a wide variety of complex tasks such as image recognition, High-Performance Computing (HPC), scientific computing, machine learning, data mining, speech recognition, and self-driving vehicles. Most Artificial Intelligence applications tend to rely very heavily on matrix operations from the mathematical field of linear algebra. Specifically, matrix operations are required to implement artificial neural networks (ANNs) that may learn from a set of training data and then later apply that learning to new input data in order to draw inferences about that new input data.

Due to this very heavy usage of matrix computations, artificial intelligence is a very computationally intensive field of computing desperately in need of processor computation optimizations. One of the most popular techniques to improve artificial intelligence application performance is to create specialized digital processing circuits for performing the matrix mathematical operations needed to implement an artificial neural network. Specialized matrix processors can take advantage of the abundant parallelism inherent in matrix mathematical operations and thus efficiently perform the matrix calculations commonly used within artificial intelligence.

Artificial Intelligence systems perform vast amounts of matrix calculations. The matrix calculations performed by artificial intelligence systems often involve processing different sized matrices. Similarly, an Artificial Intelligence application generally involves processing data through a long series of matrix operations that generate a final result along with intermediate results that may be needed for additional operations. Therefore, it is desirable to develop new techniques and circuits for quickly performing matrix mathematical operations on many different sized matrices to optimize the performance of artificial neural networks.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings generally illustrate, by way of example, but not by way of limitation, various embodiments discussed in the present document.

FIG. 1A illustrates a conceptual diagram of a single-layer artificial neural network.

FIG. 1B illustrates a conceptual diagram of a three-layer artificial neural network.

FIG. 2A illustrates a block diagram of an eight by one multiply-add unit circuit that may be used as a building block for a matrix multiplication circuit.

FIG. 2B illustrates a conceptual diagram of an eight-by-eight matrix multiplication circuit constructed using eight of the multiply-add unit circuits depicted in FIG. 2A.

FIG. 2C illustrates the eight-by-eight matrix multiplication circuit of FIG. 2B depicted in grid notation form.

FIG. 3A illustrates a block diagram of four different eight by eight matrix multiplication circuits from FIG. 2C used to create a sixteen-by-sixteen matrix multiplication circuit.

FIG. 3B illustrates the sixteen-by-sixteen matrix multiplication circuit of FIG. 3A in core notation form.

FIG. 3C illustrates the thirty-two-by-thirty-two matrix multiplication circuit in core notation form.

FIG. 3D illustrates a sixty-four-by-sixty-four matrix multiplication circuit in core notation form.

FIG. 4A illustrates a block diagram of a matrix processor circuit that may be used to perform matrix calculations.

FIG. 4B illustrates a block diagram of a matrix processor circuit with bus interfaces on all sides.

FIG. 5A illustrates a thirty-two-by-thirty-two matrix multiplication circuit performing a 100% efficient thirty-two by thirty-two matrix multiplication operation.

FIG. 5B illustrates a thirty-two-by-thirty-two matrix multiplication circuit performing a 75% efficient twenty-four by thirty-two matrix multiplication operation.

FIG. 5C illustrates a thirty-two-by-thirty-two matrix multiplication circuit performing a 50% efficient sixteen-by-thirty-two matrix multiplication operation.

FIG. 5D illustrates a thirty-two-by-thirty-two matrix multiplication circuit performing a 25% efficient sixteen-by-sixteen matrix multiplication operation.

FIG. 6A illustrates a thirty-two-by-thirty-two matrix multiplication circuit performing two different sixteen-by-sixteen matrix multiplication operations with the use of very large crossbar switches.

FIG. 6B illustrates the thirty-two-by-thirty-two matrix multiplication circuit of FIG. 6A with an additional crossbar switch to direct output data vectors.

FIG. 6C illustrates a thirty-two-by-thirty-two matrix multiplication circuit performing two different sixteen-by-sixteen matrix multiplication operations without a crossbar switch.

FIG. 7A illustrates a thirty-two-by-thirty-two matrix multiplication circuit performing two different sixteen-by-sixteen matrix multiplication operations with the use of small crossbar switches.

FIG. 7B illustrates a thirty-two-by-thirty-two matrix multiplication circuit performing two different sixteen-by-sixteen matrix multiplication operations with the use of smaller crossbar switches.

FIG. 7C illustrates a thirty-two-by-thirty-two matrix multiplication circuit performing of FIG. 7A with the use of an additional crossbar switch at the data output.

FIG. 8A illustrates a thirty-two-by-thirty-two matrix multiplication circuit performing four different eight-by-eight matrix multiplication operations with the use of small crossbar switches.

FIG. 8B illustrates a thirty-two-by-thirty-two matrix multiplication circuit performing four different eight-by-eight matrix multiplication operations with the use of smaller crossbar switches.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments may not be required in order to practice the present invention. For example, although some of the example embodiments are disclosed with reference to a specific matrix processor circuit implementation, the disclosed techniques may be used with any other implementations of a matrix processor circuit. The example embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

### Neural Networks Overview

One of the core techniques in artificial intelligence (AI) is the use of artificial neural networks (ANNs). Artificial neural networks first learn from training data and then are later used to make logical inferences on new input data presented to the trained artificial neural network. Artificial neural networks were originally designed to be roughly similar to the biological neuron networks in animal brains although the analogy is simplistic.

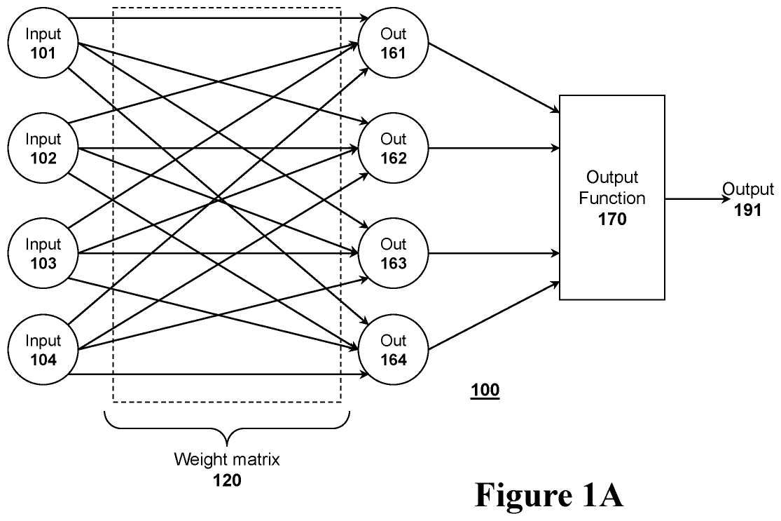

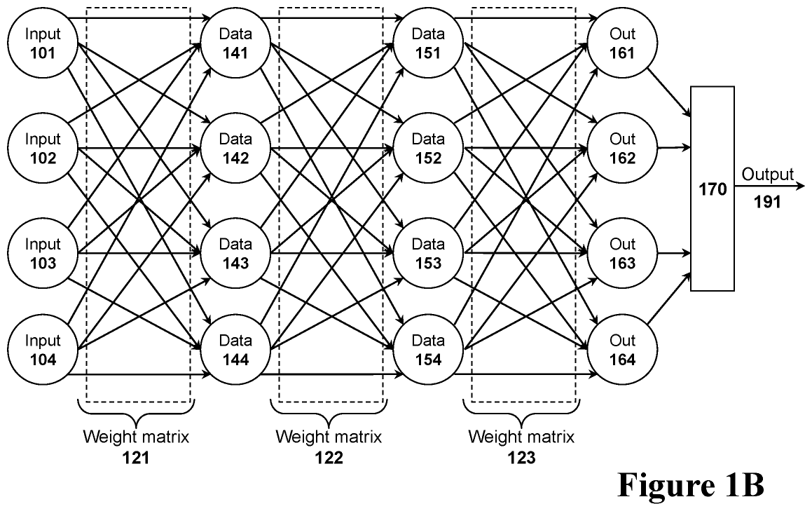

FIG. 1A illustrates a conceptual diagram of a very simple single-layer four-input artificial neural network 100. Referring to FIG. 1A, an input data vector (made up of input data 101 to 104) is provided with training data during training sessions and then with new input data when the artificial neural network is used to make inferences. The input data vector (made up of input data 101 to 104) is processed with weight data stored in a weighted matrix 120 to create an output data vector (made up of output data 161 to 164). Many different types of data processing may be performed using weighted matrix 120 (such as a Hadamard product, Frobenius inner product, matrix addition, etc). However, sections of this document will largely focus on the well-known matrix multiplication function.

After processing the input data vector with the weighted matrix 120 the system creates the output data vector (made up of output data 161 to 164). The output data vector may be combined with an output function 170 to create a final output 191 for the artificial neural network 100. The output function 170 may be referred to as an activation function. During training sessions, the output data may be compared with a desired target output (not shown) and the difference between the output data and the desired target output may be used to adjust the weight data within weight matrix 120 to improve the inference accuracy of the artificial neural network 100.

Note that the four-input artificial neural network of FIG. 1A illustrates just one example of a extremely simple small artificial neural network 100. Artificial neural networks are generally constructed much wider than just four inputs and may consist of many more layers. Furthermore, multiple independent artificial neural networks may be used in parallel, and the outputs of the independent parallel artificial neural networks may be combined.

Artificial neural networks may comprise many layers of large weight matrices such that very complex computational analysis of the input data vector may be performed. For example, FIG. 1B illustrates a three-layer artificial neural network wherein the input data vector (made up of inputs 101 to 104) is processed with a first weighted matrix 121 to create a first intermediate data vector (made up of data 141 to 144). Next, the first intermediate data vector (made up of data 141 to 144) is processed with a second weighted matrix 122 to create a second intermediate data vector (made up of data 151 to 154). Then second intermediate data vector (made up of data 151 to 154) is processed with a third weighted matrix 123 to create the output data vector (made up of outputs 161 to 164). The output data vector (made up of outputs 161 to 164) may then be processed by output function 170 to create a final output 191. Alternatively (or in addition to), the output data vector (made up of outputs 161 to 164) may also be used as intermediate data that is fed into additional artificial neural network layers (not shown) such that very complex hierarchical artificial neural networks may be created.

### Example Matrix Processor Circuit

As illustrated with reference to FIGS. 1A and 1B, neural network based artificial intelligence relies upon large amounts of very computationally intensive matrix mathematical operations to initially learn using training data to adjust the weights in the weight matrices. Later, those adjusted weight matrices are used to perform complex matrix computations with a set of new input data to draw inferences upon the new input data. Fortunately, the linear algebra matrix operations used in an artificial neural network allow for many performance optimizations to be made since there is a significant amount of parallelism inherent in the matrix computation operations that are required for artificial neural networks. Thus, specialized matrix processors that have been optimized for artificial intelligence applications have been created.

A matrix processor is a digital processing circuit that has been specifically designed to help efficiently perform the matrix computation tasks commonly used in the field of artificial intelligence. Specifically, a matrix processor is designed in a manner to rapidly read input data vectors, read matrix weight data, perform matrix computations, and write output data vectors all in a parallel manner for high data throughput. In this manner, the matrix processor can be used for forward propagation inferences as well as for backpropagation artificial intelligence neural network learning.

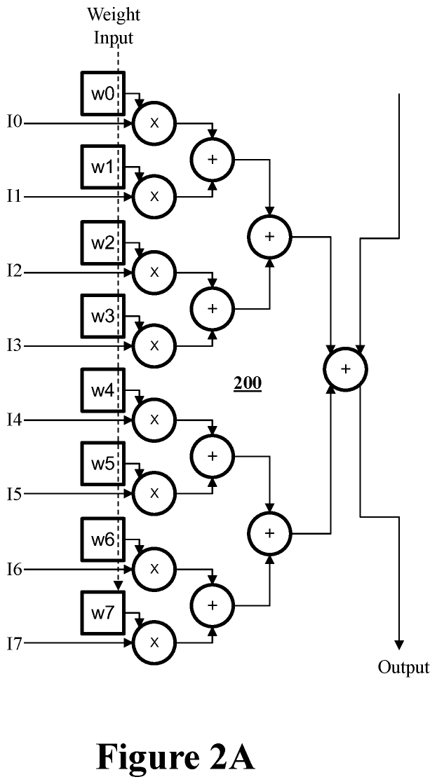

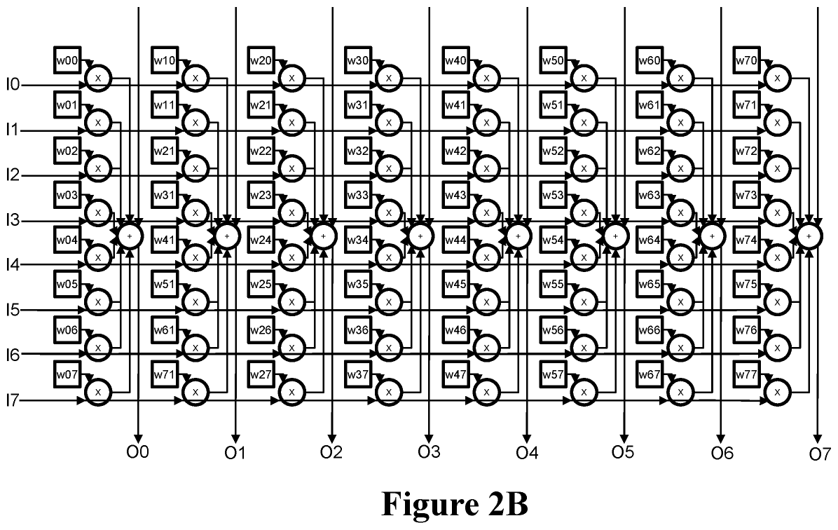

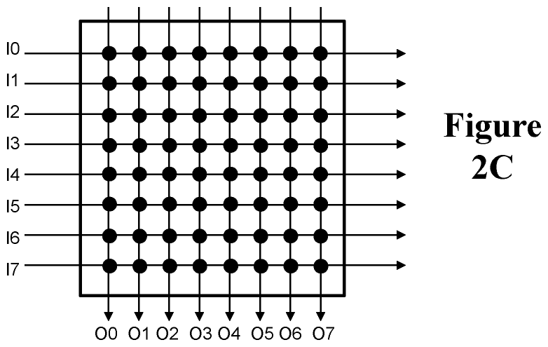

FIG. 2A illustrates a block diagram of an example parallel Multiply-Add Unit (MAU) circuit 200 that may be used within a matrix processor. The Multiply-Add Unit circuit 200 inputs an eight-element input data vector (10 to 17), multiplies the elements of that input vector with a set of corresponding weights (W0 to W7) in parallel, and adds together the results of the parallel multiplication operations to create an output. The weight values (W0 to W7) maybe input into the Multiply-Add Unit circuit 200 in a serial manner.

The Multiply-Add Unit circuit 200 can be used as a building block to create a Matrix Multiply circuit to perform matrix multiplication operations. For example, FIG. 2B illustrates an eight-by-eight Matrix Multiply circuit constructed of eight of the Multiply-Add Unit circuits 200 from FIG. 2A. The eight-by-eight Matrix Multiply circuit of FIG. 2B implements the following linear algebra matrix multiplication equation:

$$[ \begin{matrix}O 0 \\ O 1 \\ O 2 \\ O 3 \\ O 4 \\ O 5 \\ O 6 \\ O 7\end{matrix} ] = [ \begin{matrix}w 00 & w 10 & w 20 & w 30 & w 40 & w 50 & w 60 & w 70 \\ w 01 & w 11 & w 21 & w 31 & w 41 & w 51 & w 61 & w 71 \\ w 02 & w 12 & w 22 & w 32 & w 42 & w 52 & w 62 & w 72 \\ w 03 & w 13 & w 23 & w 33 & w 43 & w 53 & w 63 & w 73 \\ w 04 & w 14 & w 24 & w 34 & w 44 & w 54 & w 64 & w 74 \\ w 05 & w 15 & w 25 & w 35 & w 45 & w 55 & w 65 & w 75 \\ w 06 & w 16 & w 26 & w 36 & w 46 & w 56 & w 66 & w 76 \\ w 07 & w 17 & w 27 & w 37 & w 47 & w 57 & w 67 & w 77\end{matrix} ] \times [ \begin{matrix}I 0 \\ I 1 \\ I 2 \\ I 3 \\ I 4 \\ I 5 \\ I 6 \\ I 7\end{matrix} ]$$

The output data vector (O0 to O7) from the eight-by-eight Matrix Multiply circuit is the result of the input data vector (I0 to I7) matrix multiplied by the weight matrix (W00 to W77). To simplify some of the illustrations in this document, the eight-by-eight Matrix Multiply circuit may be represented by the simpler grid notation illustrated in FIG. 2C within this document.

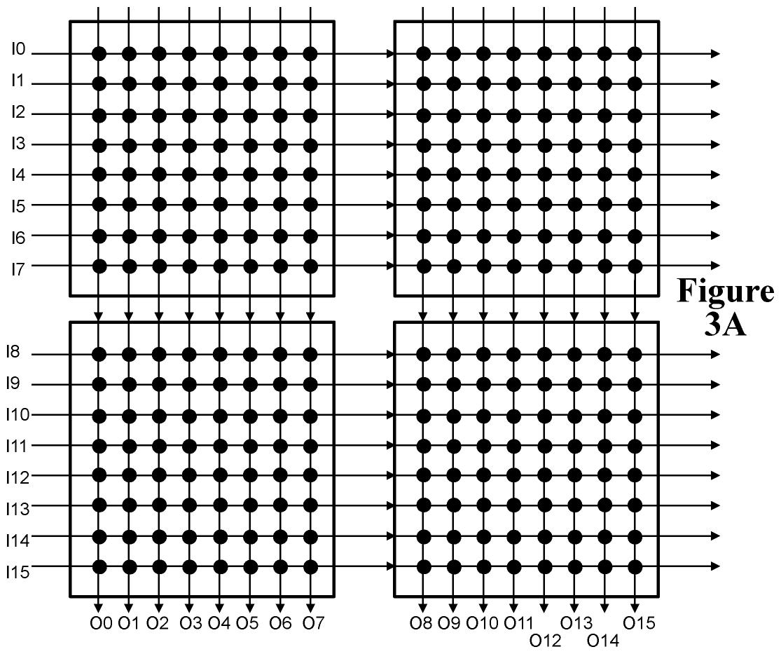

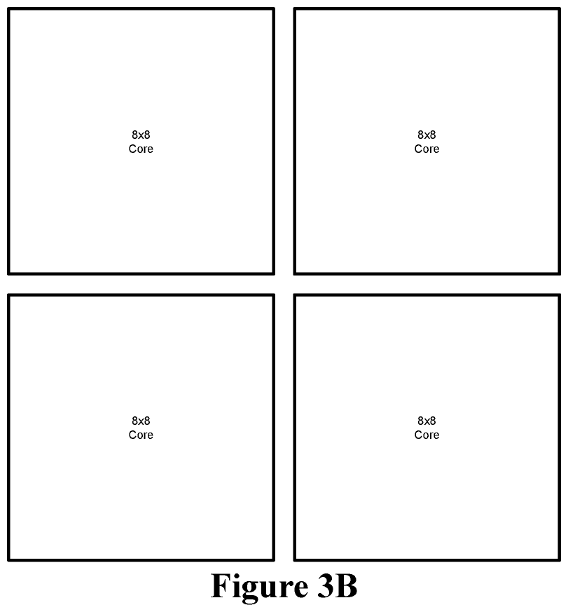

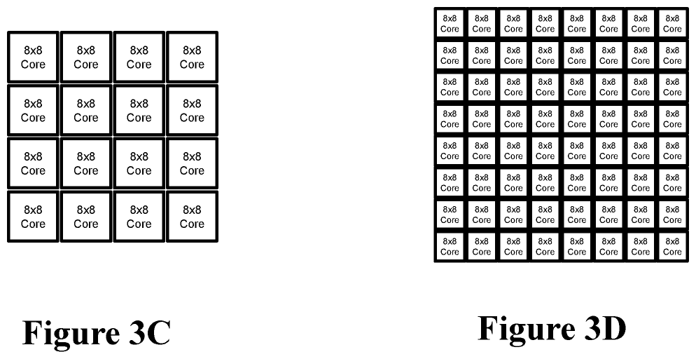

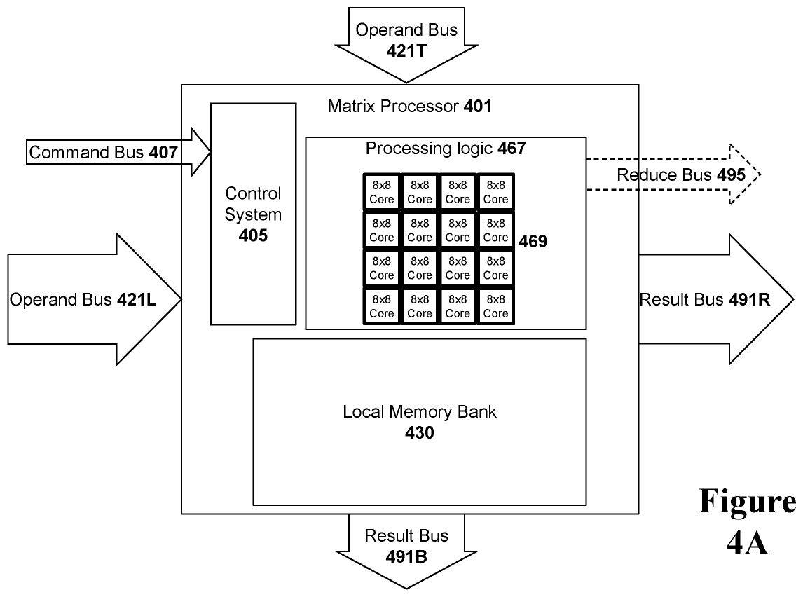

The eight-by-eight Matrix Multiply circuit of FIGS. 2B and 2C may be combined to create larger Matrix Multiply circuits capable of handling much larger matrix multiplication operations. For example, FIG. 3A illustrates four of the Matrix Multiply circuits from FIG. 2C combined to create a sixteen-by-sixteen Matrix Multiply circuit. The sixteen-by-sixteen Matrix Multiply circuit can multiply a sixteen element input data vector (I0 to I15) by a sixteen-by-sixteen weight matrix to generate a sixteen element output data vector (O0 to O15). The sixteen-by-sixteen Matrix Multiply circuit of FIG. 3A is illustrated in core notation in FIG. 3B.

Matrix Multiply circuits of any size can be created by combining many smaller Matrix Multiply circuits. FIG. 3C illustrates a thirty-two-by-thirty-two Matrix Multiply circuit created using sixteen different eight by-eight Matrix Multiply circuits. FIG. 3D illustrates a sixty-four-by-sixty-four Matrix Multiply circuit created using sixty-four different eight-by-eight Matrix Multiply circuits.

### Matrix Processor Circuit

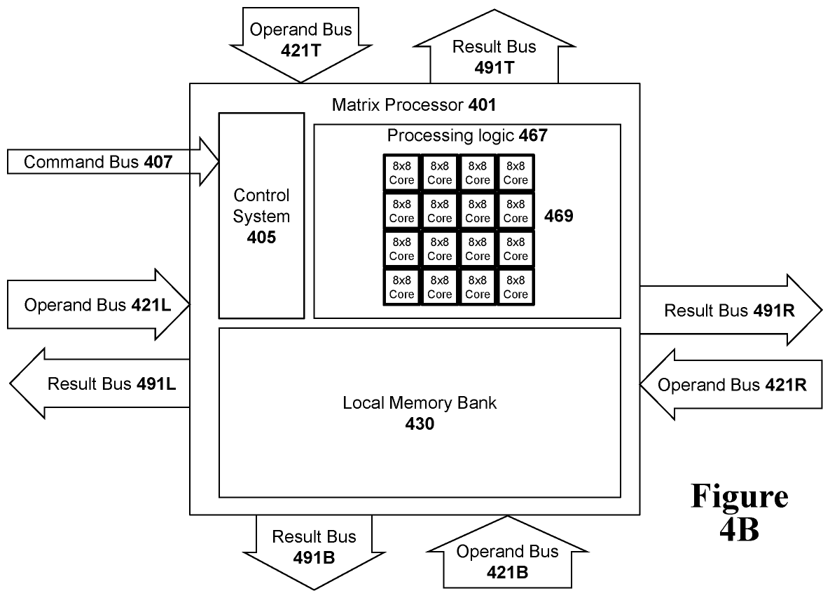

A Matrix Multiply circuit requires additional control circuitry in order to operate. Specifically, a Matrix Multiply circuit requires additional circuitry to feed in input data vectors, issue commands, and to receive output data vectors from the multiply operations. FIG. 4A illustrates a block diagram of a matrix processor circuit 401 that incorporates a thirty-two-by-thirty-two Matrix Multiply circuit 469 within the processing logic 467. The matrix processor circuit 401 of FIG. 4A includes a local memory bank 430 that may be constructed with Static Random Access Memory (SRAM). The local memory bank 430 may be configured such that entire wide rows of data can be accessed in a single memory cycle. In this manner, an entire input data vector or an entire row of weight values from a weight matrix may be read out from the local memory bank 430 or written to the local memory bank 430 in a single memory cycle.

A local control system 405 within the matrix processor circuit 401 controls all the individual circuit elements to perform the required data vector processing operations. Thus, local control system 405 selects between data stored within the wide SRAM 430 or data provided on operand bus (not shown) to be provided to the Matrix Multiply circuit 469 for processing.

The matrix processor circuit 401 receives input data on one or more operand buses. In the embodiment of FIG. 4A, there are two operand buses: operand bus from the top 421T and operand bus 421L from the left. Data received on the operand buses may be used directly by the processing logic 467 or may be stored in memory bank 430 for later usage. The data received may comprise weight matrix data, input data operand vectors, or other data.

In an alternate embodiment, operand and result buses may be placed on all of the different sides of the matrix process array circuit 401. FIG. 4B illustrates an example that has operand buses (421T, 421B, 421L, and 421R) and result buses (491T, 491B, 491L, and 491R) on all sides.

Referring back to the matrix processor circuit of FIG. 4A, the matrix processor circuit 401 also receives commands on command bus 407. The control system 405 within the matrix processor circuit 401 parses the commands received and uses the commands to determine how the processing logic 467 will be used to process data. The processing logic 467 uses the Matrix Multiply circuit 469 to perform the desired matrix mathematical operations and output the proper matrix operation results.

The matrix processor circuit 401 may be designed to operate using many different types of data formats and data precision levels. For example, the matrix processor circuit 401 may process integers, 16-bit floating point numbers, 32-bit floating point numbers, or any other data format. Although the traditional matrix multiplication operation has been discussed, many different types of matrix operations may be implemented in the matrix processor circuit 401.

The control system 405 instructs the processing logic 467 to output the results of requested matrix operations on one or more result bus 491. In some embodiments, the matrix processor 401 will include the reduction logic to output a reduced form of the result on a reduce bus 495.

The operand buses 421T and 421L may be wide parallel buses such that entire input data vectors may be loaded into the abstracted matrix processor circuit 401 in a single cycle. Similarly, entire weight matrix rows from a weight matrix may be read into the local memory bank 430 of the matrix processor circuit 401 in a single cycle. Similarly, the result buses 491R and 491B are also wide parallel buses such that entire output data vectors can be output from the matrix processor circuit 401 in a single cycle.

The local memory bank 430 may be deep in that it is constructed large enough to store multiple different sets of weight matrices. In this manner, the matrix processor circuit 401 can be used to perform matrix operations for multiple different artificial neural network layers without having to reload different matrix weight values. For example, if a matrix processor circuit 401 cannot perform an operation for one particular neural network layer because a required input data vector is not yet available for that particular neural network, then that matrix processor circuit 401 may instead be used to perform matrix operations for other neural network layers of that particular neural network or perform matrix operations for other neural networks.

In addition to storing weight values for multiple different weight matrices, the local memory bank 430 can be used to store other information that may be needed such as input data vectors, output data vectors, error vectors, etc. Intermediate result data vectors from forward pass operations may be stored in the memory local bank 430 and then later accessed when performing a related back propagation operation.

The matrix processor circuit 401 illustrated in FIGS. 4A and 4B can be used alone to perform simple matrix operations very quickly. For example, the matrix processor circuit 401 can be used to fully process the very small artificial neural network illustrated in FIG. 1. It could also be used to implement the small three-layer artificial neural network illustrated in FIG. 1B by using it serially to perform the required matrix calculations of all three artificial neural network layers 121, 122, and 123.

However, most artificial neural networks must handle much larger data input vectors and output vectors than the very small example artificial neural networks illustrated in FIGS. 1A and 1B. Therefore, one may combine the computing capabilities of many different matrix processor circuits 401 in order to process wider artificial neural networks and multi-layer artificial neural networks. In this manner, much larger multi-layer artificial neural networks that are used to perform useful artificial intelligence tasks can be handled very efficiently.

### Matrix Multiply Circuits Efficiency

Artificial neural networks may use weight matrices of many different sizes. Thus, a Matrix Processor circuit must be able to handle the processing of many different sized matrix operations. A Matrix Processor can only natively process matrices that are of the size of the Matrix Multiply circuit or smaller. Larger matrix operations can be handled by dividing the larger matrix operation into multiple smaller matrix operations that are processed in several stages with the results combined together.

A Matrix Processor operates most efficiently when the Matrix Processor operates on matrices that are of the same size of the Matrix Multiply circuit implemented within the Matrix Processor. Smaller matrix operations can be processed by adding padding data, but the efficiency of the matrix processing drops from the optimal potential throughput since operations performed on the padding data does not accomplish useful results.

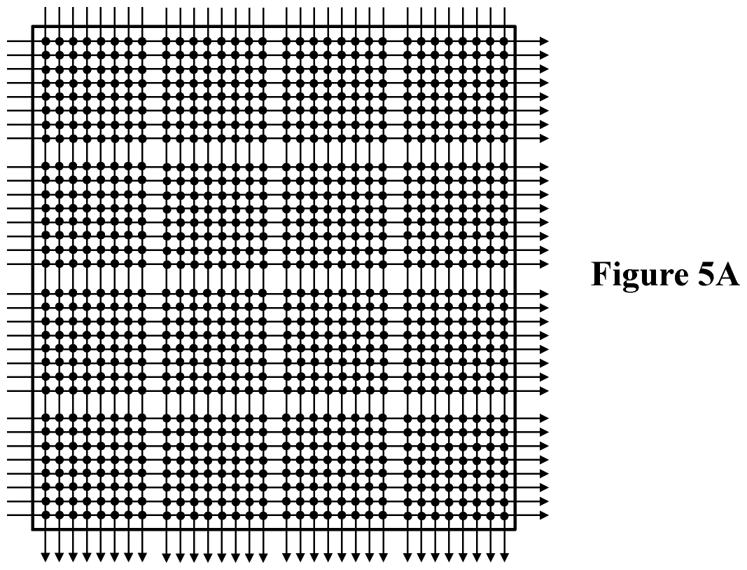

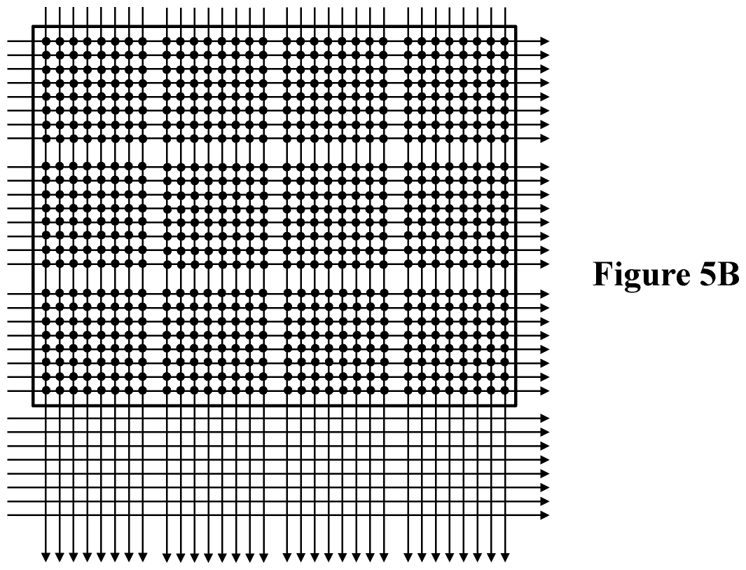

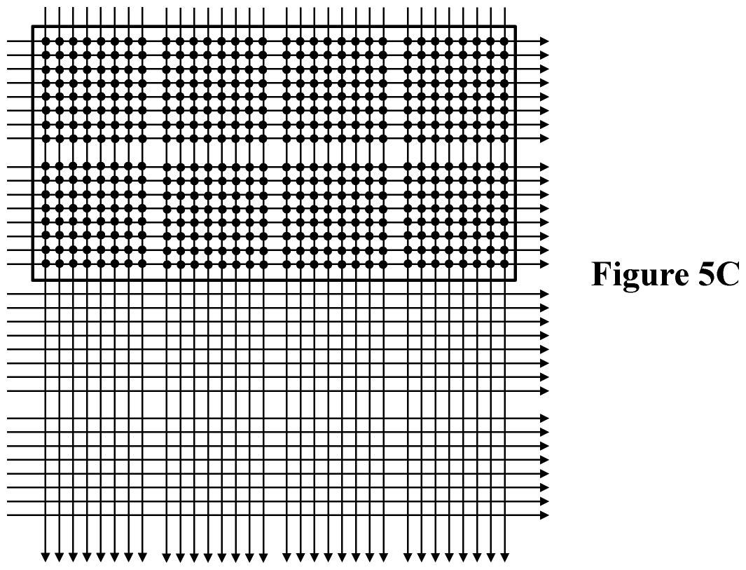

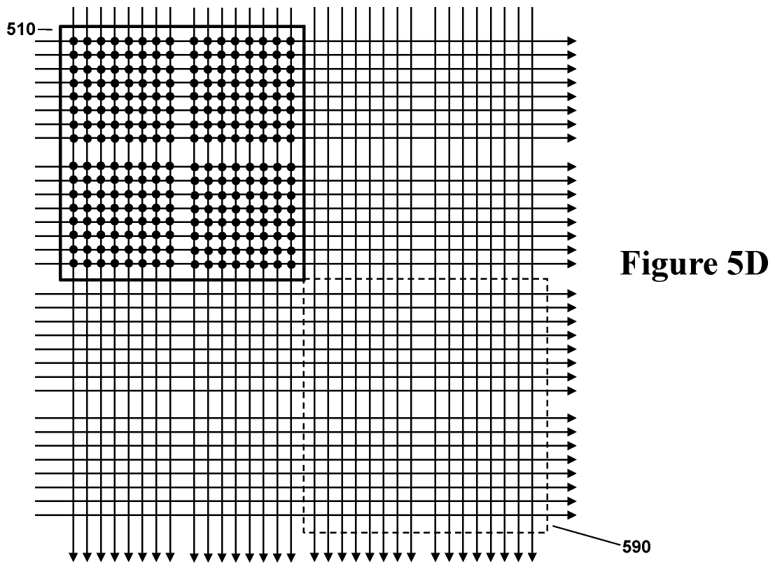

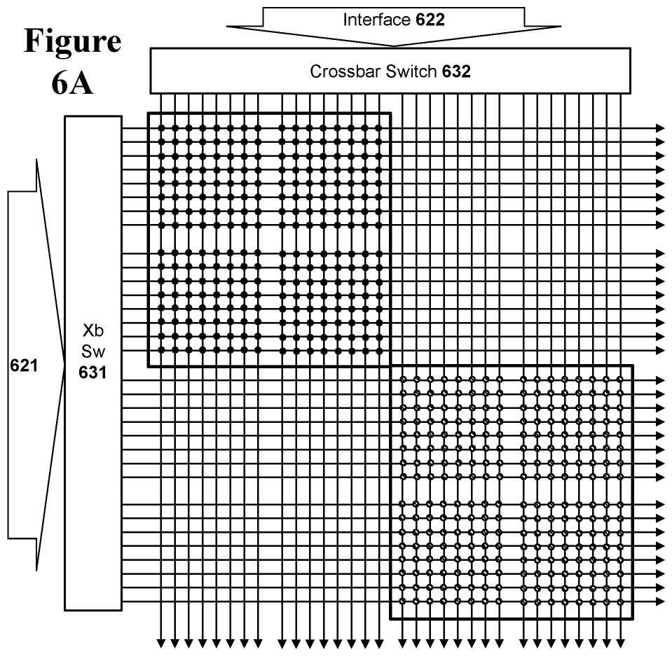

For example, FIG. 5A illustrates a thirty-two by thirty-two Matrix Multiply circuit processing a thirty-two by thirty-two matrix multiplication operation. In this optimal situation, there is a 100% efficiency since all of the Multiply-Add circuits in the Matrix Multiply circuit of FIG. 5A are used for meaningful calculations. However, when used to process a twenty-four by thirty-two matrix multiplication operation, the efficiency drops to 75% as illustrated in FIG. 5B since many of the Multiply-Add circuits will not be used for meaningful calculations. (The intersections without a dot represent circuits not being used for meaningful calculations.) Even worse, when used to process a sixteen by thirty-two matrix multiplication operation, the efficiency drops to only 50% as illustrated in FIG. 5C.

FIG. 5D illustrates a very disappointing situation where a sixteen-by-sixteen matrix multiplication operation drops the efficiency of the matrix multiplication operation all the way down to 25% since only the upper-left corner 510 of the Matrix Multiply circuit is used for a useful matrix computation. One thing that prevents better efficiency in the examples of FIGS. 5B and 5C is that there is a shortage of input and output lines that could be used for another simultaneous computation. But in the situation depicted in FIG. 5D, the bottom right corner 590 of the Matrix Multiply circuit has both input and output lines that are not currently being used since the sixteen-by-sixteen matrix multiplication operation is restricted to the upper left corner 510. To improve the efficiency of the situation depicted in FIG. 5D, it would be desirable to use that currently unused bottom right corner 590 of the Matrix Multiply circuit.

One reason why it is difficult to use the bottom right corner 590 of the Matrix Multiply circuit of FIG. 5D is that a second completely different input data vector must be provided into the Matrix Multiply circuit of FIG. 5D at the same time as the first input data vector is provided for the matrix multiplication in the upper left corner 510. In addition, a completely different weight matrix may also be required for the sixteen by sixteen matrix multiplication operation to be performed in the lower right corner 590.

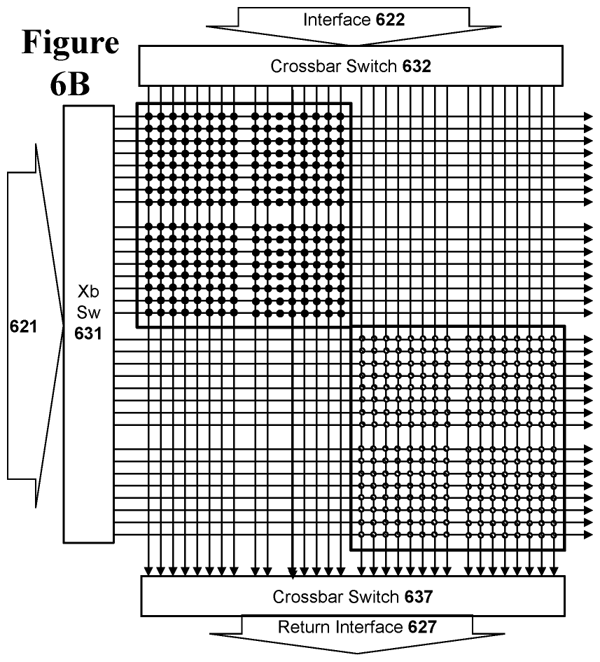

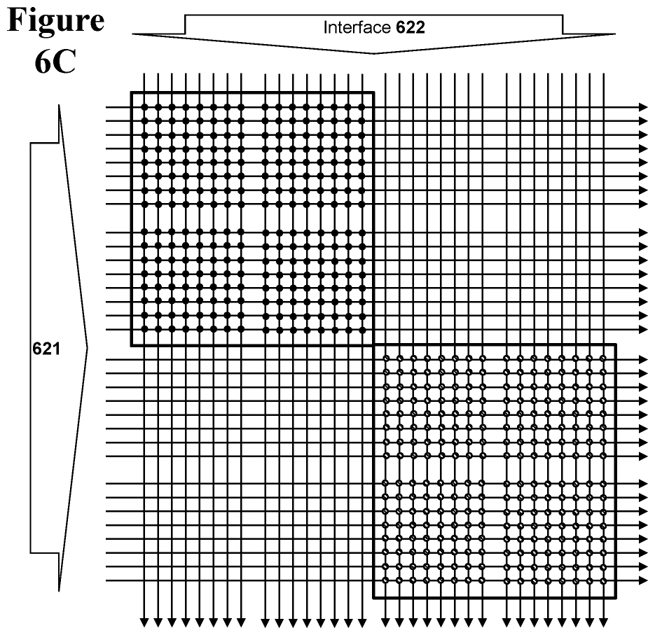

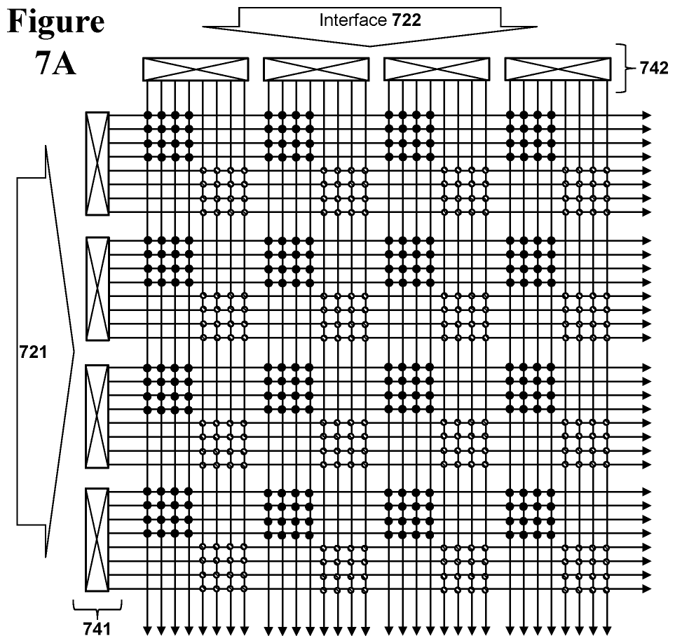

FIG. 6A illustrates a first method of solving the problem of supplying a different input data vector to the Matrix Multiply circuit. FIG. 6A illustrates the thirty-two by thirty-two Matrix Multiply circuit supplemented by a large crossbar switch 631 for the input data vector and a large crossbar switch 632 weight matrix input lines. This allows input data vectors (and weight matrix values) for two completely different sixteen-by-sixteen matrix multiplication operations to be sent to the Matrix Multiply circuit concurrently by directing the input data vectors to the proper input lines of the matrix multiply circuit. Thus, the thirty-two-by-thirty-two Matrix Multiply circuit will be able to perform two independent sixteen-by-sixteen matrix multiplication operations concurrently.

With the addition of the crossbar switches, the thirty-two-by-thirty-two Matrix Multiply circuit is able to double its efficiency to 50% by performing two independent sixteen-by-sixteen matrix multiplication operations simultaneously. However, this increase in computational efficiency comes at a very great cost. Specifically, the physical circuit layout of those large crossbar switches 631 and 632 take a very large amount of silicon die area on the matrix processor design. Furthermore, the two large crossbar switches also consume a large amount of power to operate since a very large number of transistors must be switched to direct the input data vectors to the proper locations. Thus, between the amount of integrated circuit die area required to implement a large crossbar switch and the additional power consumed by the large crossbar switch, the design of FIG. 6A is impractical since the gain in computational efficiency is not worth the additional die space needed and the additional power consumption needed to obtain that increased efficiency. Furthermore, when this large crossbar switch solution is scaled up for even larger matrix multiplication circuits, the two problems of die area and power consumption grow even worse.

It should be further noted that the data output may also need to have a large crossbar switch to operate properly. Specifically, a crossbar switch may be needed to return the output data vectors to the proper location in the memory system. Alternatively, the crossbar switch may direct the output data vectors to an accumulator or further processing stages for the output data vectors. Thus, three crossbar switches would make the system of FIG. 6B even more impractical.

It is possible to execute two different sixteen-by-sixteen matrix multiplication operations simultaneously without crossbar switches as illustrated in FIG. 6C. However, without the crossbar switch the two different input data vectors always need to be placed in the exact correction position within the memory system. This is a very difficult constraint to satisfy and generally leads to substantial amounts of additional work to carefully organize the data vectors within the memory system. Furthermore, this constraint will also tend to lead to a significant amount of duplicated data stored in the memory system. Thus, the system illustrated in FIG. 6C does not prevent a good solution.

### Improved Matrix Multiply Circuit

As set forth above, the matrix multiplication circuit designs of FIGS. 6A and 6B are impractical due to the large crossbar switches used to direction input data vectors, weight matrices, and output data vectors. And the system without any crossbar switch of FIG. 6C leads to a system that is very difficult to use and thus impractical.

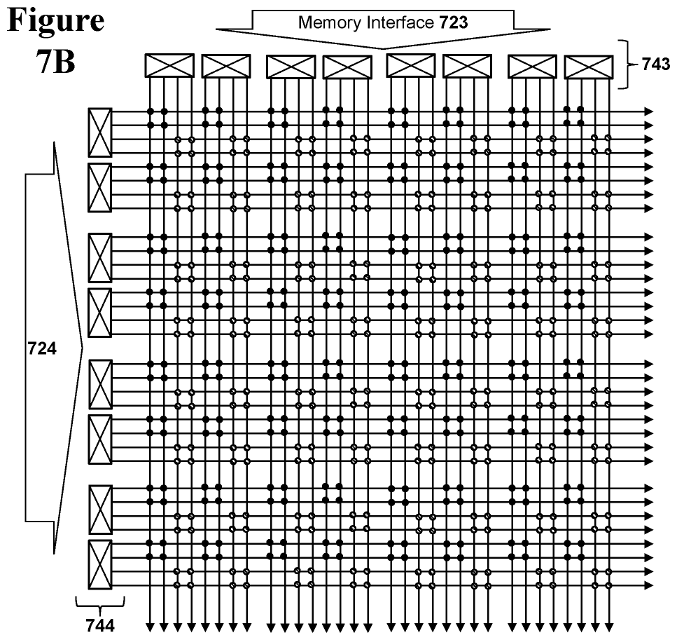

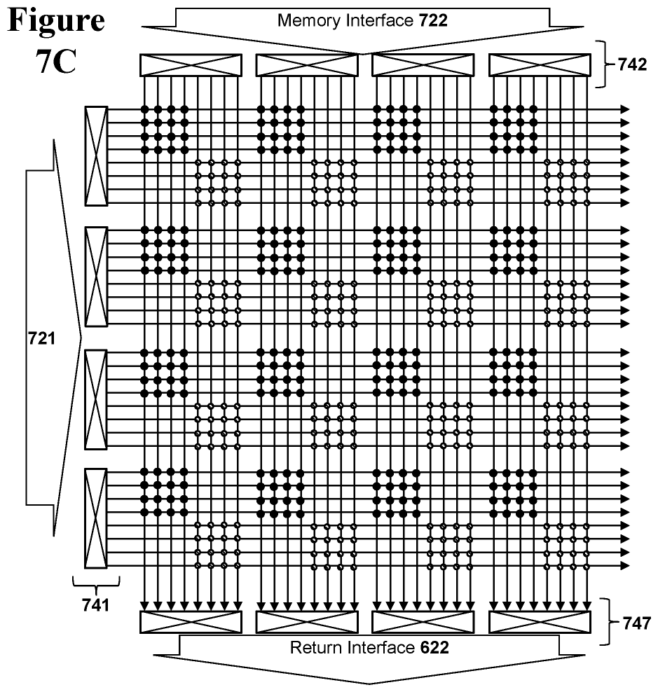

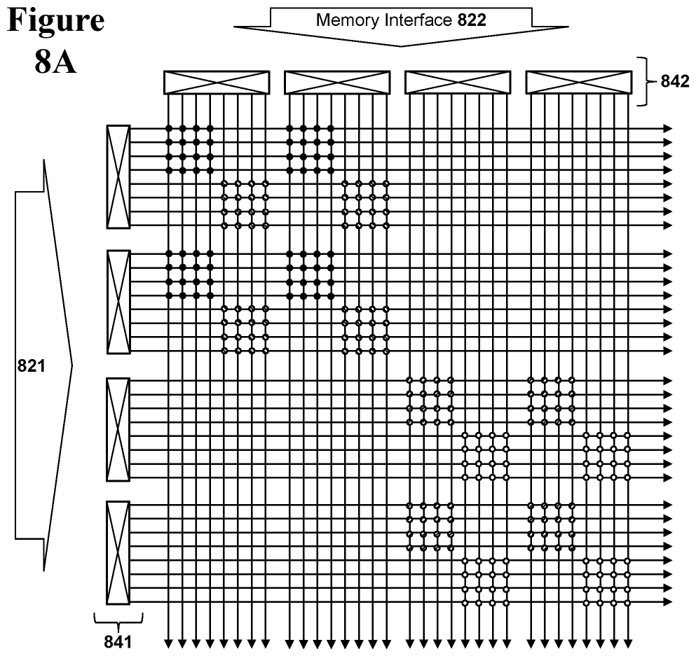

However, the intended goal of the can be accomplished by instead using a large set of smaller local crossbar switches. FIG. 7A illustrates a thirty-two-by-thirty-two Matrix Multiply circuit wherein four groups of eight adjacent input lines are serviced by a local eight-way crossbar switch. In this manner, the very strict memory location requirements of input data vectors from the system of FIG. 6C are not present such that the system is easier to work with. But the system doesn't require the very large full sized crossbar switches that are used in FIGS. 6A and 6B.

Referring to FIG. 7A, two independent sixteen-by-sixteen matrix multiplication operations are performed by the thirty-two-by-thirty-two Matrix Multiply circuit. The input data vectors come into the circuit via interface 721 and are directed using crossbar switches 741. Similarly, the weight matrices may enter through interface 722 and are directed by the four crossbar switches 742.

The sets crossbar switches 741 and 742 eliminate the problem of the very large crossbar switch that can grow exponentially in size as the Matrix Multiply circuit is scaled to larger sizes. However, the sets crossbar switches 741 and 742 allow for flexibility in where the input data vectors and weight matrices can be stored in memory. An additional crossbar switch (not shown) may also be placed on the output lines to direct the two output data vectors to the proper locations.

Note the checkerboard pattern in the system FIG. 7A. When a system operates as illustrated in FIGS. 6A to 6C the highly concentrated calculations may cause power density spikes in subsections of the integrated circuit die and thus make it difficult for the circuits of FIGS. 6A to 6C to operate reliably. To reduce any power density issues, the computations are spread around the matrix multiply circuit in wider manner as illustrated in FIG. 7A.

Note that embodiment of FIG. 7A illustrates just one possible embodiment that combines smaller crossbar switches and matrix multiplication operations spread around the Matrix Multiply circuit. FIG. 7B illustrates an alternate embodiment of a thirty-two-by-thirty-two matrix multiply circuit wherein two sixteen-by-sixteen matrix multiplication operations can be performed concurrently. In the alternate embodiment of FIG. 7B the two different sixteen-by-sixteen matrix multiplication operations are spread even thinner around the thirty-two-by-thirty-two Matrix Multiply circuit. In the embodiment of FIG. 7B, the Matrix Multiply circuit uses eight sets of four-way crossbar switches (743 and 744). Note that the power density of the calculations performed in the embodiment of FIG. 7B is very low to improve reliability. Again note that an additional crossbar switch (not shown) may also be placed on the output lines to direct the two output data vectors to the proper locations.

### Concurrent Smaller Matrix Multiply Operations

The ability to perform smaller concurrent matrix multiplication operations improves the efficiency of the Matrix Multiply circuit from 25% efficiency in FIG. 5D to 50% efficiency in FIGS. 7A and 7B. However, this is only for sixteen-by-sixteen matrix multiplication operations. But the techniques of FIGS. 7A and 7B can also be used to perform multiple concurrent matrix multiplication operations of even smaller matrices.

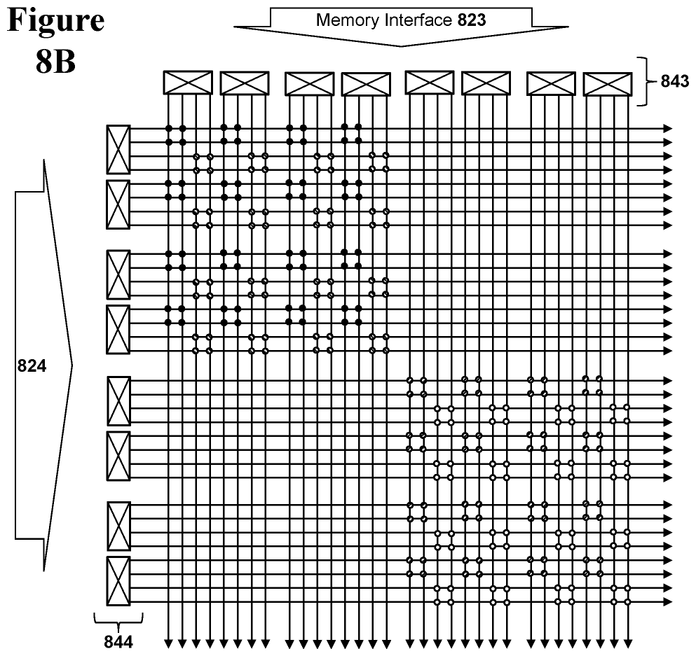

FIG. 8A illustrates a Matrix Multiply circuit wherein instead of two sixteen-by-sixteen matrix multiplication operations there are four independent eight-by-eight matrix multiplication operations being performed simultaneously. The arrangement of FIG. 8A, takes advantage of the eight-way crossbar switches to allow the data to be stored in many different locations. Similarly, FIG. 8B illustrates the Matrix Multiply circuit of FIG. 7B wherein instead of two sixteen-by-sixteen matrix multiplication operations there are four independent eight-by-eight matrix multiplication operations being performed simultaneously. With the embodiment of FIG. 8B, the power density is spread better.

The efficiency of the four independent eight-by-eight matrix multiplication operations is not high since much of the available computation circuitry is not being used as can be seen in FIGS. 8A and 8B. However, executing four independent eight-by-eight matrix multiplication operations simultaneously is much more efficient than if only one or two eight-by-eight matrix multiplication operations were being performed.

The preceding technical disclosure is intended to be illustrative and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim is still deemed to fall within the scope of that claim. Moreover, in the following claims, the terms “first,” “second,” and “third,” etc. are used merely as labels and are not intended to impose numerical requirements on their objects.

The Abstract is provided to comply with 37 C.F.R. § 1.72 (b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

We claim:

1. An apparatus for performing neural network operations in a neural network processor, said apparatus comprising the elements of:
a N-dimensional array of logic circuits, said N-dimensional array of logic circuits comprising
a set of input data lines for receiving at least one input data vector,
a set of weight matrix input lines for receiving a set of matrix weights,
a logic circuit for performing a matrix arithmetic operation combining said input data vectors and said set of matrix weights, and
a set of output data lines for outputting at least one output data vector from said matrix arithmetic operation; and
more than one input data crossbar switches, each input data crossbar switch coupled to a subset of adjacent input data lines.

2. The apparatus for performing neural network operations in a neural network processor as set forth in claim 1 further comprising a set of addition circuits, said addition circuits for adding together matrix multiply output data from aligned output lines.

3. The apparatus for performing neural network operations in a neural network processor as set forth in claim 2 wherein said set of addition circuits are constructed within said two-dimensional array of matrix processors.

4. The apparatus for performing neural network operations in a neural network processor as set forth in claim 2 wherein said set of addition circuits are outside of said two-dimensional array of matrix processors.

5. The apparatus for performing neural network operations in a neural network processor as set forth in claim 1 further comprising
more than one output data crossbar switches, each output data crossbar switch coupled to a subset of adjacent output data lines.

6. The apparatus for performing neural network operations in a neural network processor as set forth in claim 1 further comprising
more than one weight matrix crossbar switches, each weight matrix crossbar switch coupled to a subset of adjacent weight matrix input lines.

7. The apparatus for performing neural network operations in a neural network processor as set forth in claim 6 wherein said weight matrix crossbar switches in claim 5 are constructed within said N-dimensional array.

8. The apparatus for performing neural network operations in a neural network processor as set forth in claim 6 wherein said weight matrix crossbar switches are paired with local memory store constructed within said N-dimensional array.

9. The apparatus for performing neural network operations in a neural network processor as set forth in claim 1 wherein said matrix arithmetic operation comprises a matrix multiplication operation.
